(19) United States
(12) Patent Application Publication
(10) Pub. No.: US 2007/0002745 A1
(43) Pub. Date: Jan. 4, 2007

(54) Discard-sniffing device and method

(75) Inventors: Valentin Ossman, Netanya (IL); Oren Spector, Haifa (IL)

Correspondence Address: DR. MARK FRIEDMAN LTD.;C/o Bill Polkinghorn, 9003 Florin Way, Upper Marlboro, MD, 20772, US

(73) Assignee: PMC-SIERRA ISRAEL LTD.

(21) Appl. No.: 11/477,443

(22) Filed: Jun. 30, 2006

Related U.S. Application Data
(60) Provisional application No. 60/695,532, filed on Jul. 1, 2005.

(51) Int. Cl. H04J 1/16

(52) U.S. Cl. 370/235

(57) ABSTRACT

The present invention discloses devices and methods for identifying, analyzing, and repairing network problems. The present invention can be implemented various types of networks including a packet-switched network and an Ethernet passive optical network (EPON), caused by a variety of reasons, culminating in undesirable packet discard. A method of discard-sniffing (DS) is disclosed for monitoring discarded network traffic. A discard reason register stores discard decisions and indications for discard-designated frames, allowing a network administrator to analyze causes for frames being discarded. The discard-designated frames can be routed to alternate destinations based on their designation. Optionally, a configuration register is available to disable DS capability.

This patent application claims the benefit of U.S. Provisional Patent Application No. 60/695,532 filed Jul. 1, 2005.

### FIELD AND BACKGROUND OF THE INVENTION

The present invention relates to devices and methods for identifying, analyzing, and repairing network problems, on packet-switched network systems, caused by a variety of reasons, culminating in undesirable packet discard.

In packet-switched network systems, each network element receives packets from neighboring elements, and sends packets to neighboring elements according to some set of rules. A network element may discard an incoming packet due to a variety of reasons, some desirable and some not.

The purpose of a packet-switched network is to transfer packets from their source to their destination. In most cases, a packet that does not reach its destination must be retransmitted by its source. Although, such a retransmission is not issued by the network itself, but rather by higher-level applications which recognize that some packets did not reach their destination. This has a detrimental effect both on the transmission delay that the packet incurs, and on the utilization of the network.

When a network problem is caused by packet discard, it is often hard to tell the root cause of the problem. Standard network elements provide basic diagnostic methods for analyzing packet discard in the form of counters. There are standard packet counters such as those specified by RMON, the Remote MONitoring network protocol (see RFC 2819—Remote Network Monitoring Management Information Base available at http://www.faqs.org/rfcs/rfc2819.html). These counters include, among other things, bad CRC packets, undersized packets, and oversized packets. Monitoring these counters can help understand reasons for packet discard.

The weaknesses of the counter methods for solving the problems described above are:

(1) Counters cannot be read too often, so they cannot provide information regarding the distribution of discards over time. Discard distribution may indicate queuing problems.

(2) Counters cannot provide information regarding the decisions taken by the network element, in regards to a discarded packet, in order to detect configuration problems causing undesirable discards.

(3) Counters cannot provide the contents of discarded packets which can help in analyzing common characteristics of discarded packets.

(4) Counters cannot provide the discard reason for a specific packet.

As mentioned before, packet discard may occur in all types of packet-switched networks. The present invention is relevant to EPON (Ethernet over Passive Optical Network) networks as well as to standard Ethernet networks.

The EPON network consists of an OLT (Optical Line Terminal) device and several ONU (Optical Network Unit) devices connected by fiber optics. The OLT has two ports: CNI (Core Network Interface) and PON (Passive Optical Network). The ONU has also two ports: UNI (User Network Interface) and PON.

The OLT PON port is connected to a fiber optic which goes into a passive optical splitter. The splitter splits the OLT fiber into several fiber optics. Each split fiber optic can be connected to the PON port of an ONU. A split fiber optic may also be connected to a traffic analyzer device. Each ONU has a dedicated number, called an LLID (Logical Link IDentifier), which is assigned to the ONU upon its connection to the EPON network. The LLID is used by the ONU in order to filter only the traffic intended for the ONU. The OLT uses the LLID in order to identify the ONU traffic.

The CNI and UNI ports are standard Ethernet ports, which are capable of transmitting and receiving standard Ethernet frames. The PON ports are a variant of Ethernet ports. These ports are capable of transmitting and receiving Ethernet frames, but with a special Ethernet preamble. This preamble contains, among other things, an LLID field. A frame transmitted by the OLT has a preamble with the LLID of the ONU to which the frame is destined. A frame transmitted by the ONU has a preamble with the LLID of the transmitting ONU.

It would be desirable to have systems and methods for overcoming the weaknesses of frame discard analysis using counters. Moreover, it would be desirable to be able to identify undesirable frame discard situations and to be able to fix them.

### SUMMARY OF THE INVENTION

It is the purpose of the present invention to provide devices and methods for identifying, analyzing, and repairing network problems, on packet-switched network systems (including EPON networks), caused by a variety of reasons, culminating in undesirable packet discard.

For the purpose of clarity, several terms which follow are specifically defined for use within the context of this application. The terms “frame” and “packet” are used interchangeably herein. The term “discard” is used in this application to refer to a frame that does not reach its intended destination. The term “sniffing” is used in this application to refer to the monitoring of network traffic without affecting the traffic.

Therefore, according to the present invention, there is provided for the first time a method for detecting discarded frames, the method including the steps of: (a) providing a network for routing frames of data; (b) routing the frames through a device, wherein the device includes at least one functional block for detecting a discard-designated frame; (c) setting at least one discard functionality, in each functional block, to indicate a detection of each discarded frame; and (d) storing values of at least one discard functionality in a discard reason register.

Preferably, the step of providing a network includes providing a packet-switched network.

Preferably, the step of providing a network includes providing an Ethernet passive optical network (EPON).

Preferably, the step of routing through a device includes a device having a configuration register operative to disable the detection.

Preferably, the step of setting at least one discard functionality includes setting at least one discard functionality selected from the group consisting of: a flag counter, a logical link identifier, a tag offset, a discard decision, and a configuration-dependent indication.

Preferably, at least one discard functionality can be attached to the discard-designated frame.

Preferably, the discard-designated frame can be routed to at least one alternate destination based on at least one discard functionality.

Most preferably, at least one alternate destination includes a network management system.

According to the present invention, there is provided for the first time a device for detecting discarded frames, the device including: (a) at least one functional block for detecting each discarded frame in a data network; (b) at least one discard functionality, in each functional block, to indicate a detection of a discard-designated frame; and (c) a discard reason register for storing values of at least one discard functionality.

Preferably, the data network is a packet-switched network.

Preferably, the data network is an Ethernet passive optical network (EPON).

Preferably, the device further includes: (d) a configuration register operative to disable the detection.

Preferably, at least one discard functionality includes at least one functionality selected from the group consisting of: a flag counter, a logical link identifier, a tag offset, a discard decision, and a configuration-dependent indication.

Preferably, at least one discard functionality is configured to be attached to the discard-designated frame.

Preferably, the discard-designated frame is configured to be routed to at least one alternate destination based on at least one discard functionality.

Most preferably, at least one alternate destination includes a network management system.

These and further embodiments will be apparent from the detailed description and examples that follow.

### BRIEF DESCRIPTION OF THE DRAWINGS

The present invention is herein described, by way of example only, with reference to the accompanying drawings, wherein:

FIG. 1 is a simplified schematic block diagram of a network device for discard sniffing, according to the present invention;

FIG. 2 is a simplified flowchart showing the procedure by which a frame is processed by the device shown in FIG. 1, according to the present invention.

### DESCRIPTION OF THE PREFERRED EMBODIMENTS

The present invention relates to devices and methods for identifying, analyzing, and repairing network problems associated with packet discarding. The principles and operation for identifying, analyzing, and repairing network problems associated with packet discarding, according to the present invention, may be better understood with reference to the accompanying description and the drawings.

The problem at hand is being able to identify, analyze, and repair undesirable packet discard in networks. A network element may discard an incoming packet due to a variety of reasons, some desirable and some not. The major reasons for frame discards are: (1) bad frames due to BER (bit-error rate), (2) bridging decisions, (3) frames that are configured to be discarded due to frame content or frame length, (4) rate-limiting bandwidth, and (5) congestion (i.e. queue overflow). Bridging decisions refer to situations where a network device recognizes that the frame destination is the same port as the port from which the frame entered the device. In such cases, the device does not need to send the frame to any of the device ports, and therefore discards the frame. Rate-limiting bandwidth refers to situations in which a network administrator wants to limit the bandwidth consumed by each input or output port. In such cases, when the threshold bandwidth limit is exceeded, frames are discarded.

A network administrator needs to understand where and why frame discard occurs. The present invention allows an administrator to examine the discarded frames, and understanding the discard reason for each frame. A few examples are now provided to explain how knowing the discard reason helps to solve discard problems.

(1) If a frame analysis shows that many frames are discarded due to BER, a network administrator should check for malfunctioning equipment, such as network cables.

(2) If a frame analysis shows that many frames are discarded due to the device configuration, a network administrator should check whether the device configuration is correct, or whether the devices connected to the analyzed device are configured correctly.

(3) If a frame analysis shows that many frames are discarded due to congestion, a network administrator should check if the traffic engineering of the network was done properly. The device could be overloaded with traffic, which can be reduced by using different network configuration. Another option is to see if the congestion occurs due to bursts of incoming frames. In such a case, a device with larger queues may solve the problem.

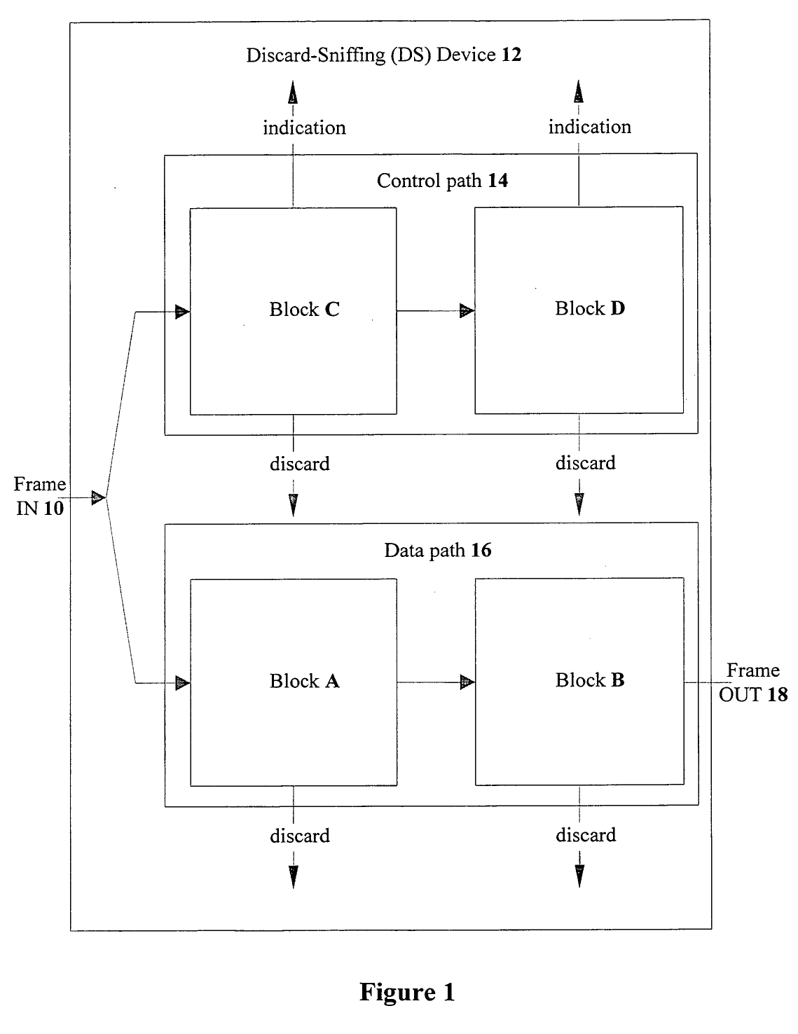

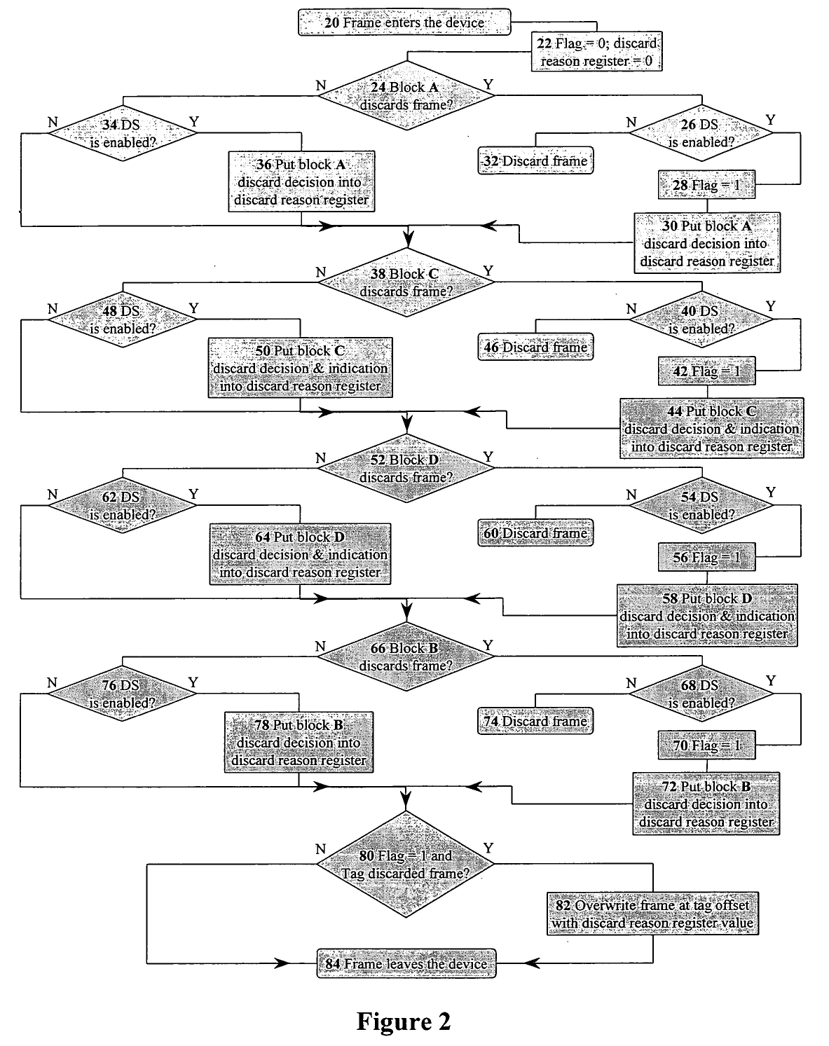

Referring now to the drawings, FIG. 1 simplified schematic block diagram of a network DS (i.e. discard sniffing) device, according to the present invention. A frame is received at a frame IN 10 where the frame enters a DS device 12. Inside DS device 12, the frame goes through several functional blocks. The frame is split into two signal paths, a control path 14 and a data path 16. Data path 16 contains a block A and a block B which both decide whether to discard or transmit the frame. Control path 14 contains a block C and a block D which both decide whether to discard or transmit the frame. However, control path 14 also provides an additional indication, depending on the control block configuration, for each block. The control block configuration may affect discard decision by other blocks. The frame leaves DS device 12 at a frame OUT 18. A more detailed explanation of how such a DS device functions is provided with regard to FIG. 2.

The indication that a control path block (i.e. block C or D) gives is not directly related to the discard decision made by that block. For example, an address table can give an indication as to whether the frame's destination address was found in the table or not. However, the address table itself does not discard frames based on this indication.

The implementation of the method consists of three parts:

(1) Adding a configuration register to the device that controls whether the method is activated, whether the LLID is used for discarded frames, and whether the discard reason is put inside the frame (i.e. overwrites some of the data). The configuration register also determines the offset of the frame to which the discard reason is written. Table 1 shows an example of the configuration register of an EPON DS device.

TABLE 1

| Name | Field | Width | Default | Description |
|---|---|---|---|---|
| enable | 0 | 1 | 0x0 | Enable discard-sniffing (DS) function. |
| | | | | 0 - frames configured to be discarded will be |
| | | | | discarded |
| | | | | 1 - frames configured to be discarded |
| | | | | will be forwarded to the DS LLID |
| tag | 1 | 1 | 0x1 | Tag frames forwarded to DS LLID with a |
| | | | | 32-bit tag containing discard reason. The tag will |
| | | | | replace existing frame data. |
| Reserved | 7:2 | 6 | 0x0 | Reserved |
| LLID | 14:8 | 7 | 0x7E | Destination LLID for discarded frames. |
| | | | | This LLID must not be used by any ONU on the |
| | | | | PON network. |
| | | | | Restricted values are all the used LLID in |
| | | | | the system and 0x7F |
| Reserved | 15 | 1 | 0x0 | Reserved |
| tag_offset | 19:16 | 4 | 0xC | DWORD (32-bit) offset from start of the |
| | | | | frame. |
| | | | | Allowed values are from 0x4 till 0xC |
| | | | | inclusive. |
| Reserved | 31:20 | 12 | 0x0 | Reserved |

(2) Gathering the various discard decisions and the configuration-dependent indications together into a register called a discard reason register. Later, the contents of the register may be put inside the discarded frame. Table 2 shows an example of the discard reason register of the DS device shown in FIG. 1.

TABLE 2

| Bits | Width | Description |
|---|---|---|
| 0 | 1 | Block A discard decision |
| 1 | 1 | Block B discard decision |
| 2 | 1 | Block C discard decision |
| 3 | 1 | Block D discard decision |
| 11:4 | 8 | Block C indication |
| 19:12 | 8 | Block D indication |
| 31:20 | 12 | Reserved |

(3) Modifying the device so that the device is able to keep a frame that should be discarded together with an indication that this is a frame that should have been discarded. When the frame is about to leave the device, the frame may be edited so that the contents of the discard reason register is put inside the frame in some configurable offset. The LLID in the configuration register is used when transmitting the frame.

For a non-EPON device, the implementation is similar. The only difference between an EPON and a non-EPON DS device is that the configuration register of a non-EPON DS device needs to hold a port number instead of an LLID. When a DS device encounters a frame that should be discarded, the frame should be written to the queue of the port indicated in the aforementioned register. The discard reason may be added to the non-EPON DS device as in the case of the EPON DS device. Table 3 shows an example of the configuration register of a non-EPON DS device. Moreover, there is an option to put several port fields in the configuration register, so that the frame will be written to the queue of each of the ports that appear in the configuration register.

TABLE 3

| Name | Field | Width | Default | Description |
|---|---|---|---|---|
| enable | 0 | 1 | 0x0 | Enable discard-sniffing (DS) function. |
| | | | | 0 - frames configured to be discarded will be discarded |
| | | | | 1 - frames configured to be discarded will |
| | | | | be forwarded to the DS port |
| tag | 1 | 1 | 0x1 | Tag frames forwarded to DS port with a 32- |
| | | | | bit tag containing discard reason. The tag will replace |
| | | | | existing frame data. |
| Reserved | 7:2 | 6 | 0x0 | Reserved |
| port | 11:8 | 4 | 0xF | Destination port for discarded frames. This port must |
| | | | | not be used for other purposes. |
| Reserved | 15:12 | 4 | 0x0 | Reserved |
| tag_offset | 19:16 | 4 | 0xC | DWORD (32-bit) offset from start of the |
| | | | | frame. |
| | | | | Allowed values are from 0x4 till 0xC |
| | | | | inclusive. |
| Reserved | 31:20 | 12 | 0x0 | Reserved |

FIG. 2 is a simplified flowchart showing the procedure by which a frame is processed by the device shown in FIG. 1, according to the present invention. In describing the operational procedure shown in FIG. 2, reference to the components shown in FIG. 1 will be made for better clarity. A frame enter DS device 12 at frame IN 10 (Step 20). A discard flag and register are set to zero (Step 22). A discard decision is made at block A to discard or transmit the frame (Step 24). If the discard decision is to discard the frame, then DS device 12 checks if discard-sniffing is enabled (Step 26). If DS is enabled, the flag is set to one (Step 28), and the discard decision for block A is placed in the discard reason register (Step 30). If DS is disabled, the frame is discarded (Step 32).

Returning to Step 24, if the discard decision is not to discard the frame by block A, then DS device 12 checks if discard-sniffing is enabled (Step 34). If DS is disabled, the process moves to block C. If DS is enabled, the discard decision for block A is placed in the discard reason register (Step 36), and the process moves to block C. It is important to note that discard decisions include both discards and transmittals. It is noted that the frame follows a parallel route through control path 14 and data path 16 as shown in FIG. 1.

The frame then follows a similar processing protocol in block C. A discard decision is made at block C to discard or transmit the frame (Step 38). If the discard decision is to discard the frame, then DS device 12 checks if discard-sniffing is enabled (Step 40). If DS is enabled, the flag is set to one (Step 42), and the discard decision and indication for block C is placed in the discard reason register (Step 44). If DS is disabled, the frame is discarded (Step 46).

Returning to Step 38, if the discard decision is not to discard the frame by block C, then DS device 12 checks if discard-sniffing is enabled (Step 48). If DS is disabled, the process moves to block D. If DS is enabled, the discard decision and indication for block C is placed in the discard reason register (Step 50), and the process moves to block D.

The frame then follows a similar processing protocol in block D. A discard decision is made at block D to discard or transmit the frame (Step 52). If the discard decision is to discard the frame, then DS device 12 checks if discard-sniffing is enabled (Step 54). If DS is enabled, the flag is set to one (Step 56), and the discard decision and indication for block D is placed in the discard reason register (Step 58). If DS is disabled, the frame is discarded (Step 60).

Returning to Step 52, if the discard decision is not to discard the frame by block D, then DS device 12 checks if discard-sniffing is enabled (Step 62). If DS is disabled, the process moves to block B. If DS is enabled, the discard decision and indication for block D is placed in the discard reason register (Step 64), and the process moves to block B.

The frame then follows a similar processing protocol in block B. A discard decision is made at block B to discard or transmit the frame (Step 66). If the discard decision is to discard the frame, then DS device 12 checks if discard-sniffing is enabled (Step 68). If DS is enabled, the flag is set to one (Step 70), and the discard decision for block B is placed in the discard reason register (Step 72). If DS is disabled, the frame is discarded (Step 74).

Returning to Step 66, if the discard decision is not to discard the frame by block B, then DS device 12 checks if discard-sniffing is enabled (Step 76). If DS is disabled, the tagging decision is made (Step 80). If DS is enabled, the discard decision for block B is placed in the discard reason register (Step 78). DS device 12 then checks the value of the flag and the value of the configuration register tag field (Step 80). If the flag equals one and the value of the configuration register tag field is one, the frame is overwritten at a tag offset with the value of the discard reason register value (Step 82). The frame then leaves DS device 12 (Step 84). If the flag equals zero or the value of the configuration register tag field is zero, then the frame leaves DS device 12 (Step 84).

It is noted that the frame does not leave DS device 12 (Step 84), until it receives the discard decisions and indications from control path 14 (i.e. both blocks C and D). Upon leaving DS device 12 (Step 84), a discard-designated frame can be routed to an alternate destination. Examples of destinations that the frames can be routed to include an alternate network port (e.g. “recycle bin”) or a network management system.

The general method for sniffing discarded frames is by using a dedicated port for outputting discarded frames. In an EPON network application, there is a single PON port, so the dedicated port approach is not feasible. However, as mentioned above, EPON networks use the LLID field in the preamble of Ethernet frames passing between the OLT and the ONU.

From this, the following application can be considered. Discarded frames are outputted through the PON port. The discarded frames are identified by a dedicated LLID called a discard LLID. The discard LLID is not used by any active ONU or for broadcast purposes. Optionally, the discard LLID may be configurable.

This method can be used for both OLT discards and ONU discards. It is easier to use the method for OLT discards, since the PON traffic going out of the OLT can be sniffed easily in the same manner as ONUs “listen” to this traffic. By listening, it is meant that when an ONU receives any frame transmitted by the OLT, the ONU filters out any frames that contain a non-broadcast LLID different from the LLID of the ONU. A traffic analyzer can perform the same function, but with the discard LLID instead. Even a standard gigabit Ethernet traffic analyzer can recognize the discarded frames marked with the discard LLID.

The method can also be used for ONU discards, but that requires a dedicated EPON traffic analyzer which can deal with the TDM (i.e. time-division multiplexing) nature of traffic going from the ONUs to the OLT. Another issue with ONU discard-sniffing is that if this is done for several ONUs at once, the discarded frames of each ONU need to be clearly identified. This can be done by using a different discard LLID for each ONU, or by adding an original LLID field in the discarded frame.

In non-EPON networks, a network administrator has to decide which devices interest him regarding frame discards. Then, the administrator configures each device to output discarded frames to a certain port; connects a traffic analyzer to that port, and analyzes the discarded frames.

The present invention can also be applied to software-based network devices, such as firewalls. A firewall discards frames based on a set of configured rules. The present invention allows such devices to store discarded frames in memory together with their discard reasons (e.g. firewall rules), and to display the contents of the memory.

While the invention has been described with respect to a limited number of embodiments, it will be appreciated that many variations, modifications, and other applications of the invention may be made.

What is claimed is:

1. A method for detecting discarded frames, the method comprising the steps of:
(a) providing a network for routing frames of data;
(b) routing said frames through a device, wherein said device includes at least one functional block for detecting each discarded frame;
(c) setting at least one discard functionality, in each said functional block, to indicate a detection of a discard-designated frame; and
(d) storing values of said at least one discard functionality in a discard reason register.

2. The method of claim 1, wherein said step of providing a network includes providing a packet-switched network.

3. The method of claim 1, wherein said step of providing a network includes providing an Ethernet passive optical network (EPON).

4. The method of claim 1, wherein said step of routing through a device includes a device having a configuration register operative to disable said detection.

5. The method of claim 1, wherein said step of setting at least one discard functionality includes setting at least one discard functionality selected from the group consisting of: a flag counter, a logical link identifier, a tag offset, a discard decision, and a configuration-dependent indication.

6. The method of claim 1, wherein said at least one discard functionality can be attached to said discard-designated frame.

7. The method of claim 1, wherein said discard-designated frame can be routed to at least one alternate destination based on said at least one discard functionality.

8. The method of claim 7, wherein said at least one alternate destination includes a network management system.

9. A device for detecting discarded frames, the device comprising:
(a) at least one functional block for detecting each discarded frame in a data network;
(b) at least one discard functionality, in each said functional block, to indicate a detection of a discard-designated frame; and
(c) a discard reason register for storing values of said at least one discard functionality.

10. The device of claim 9, wherein said data network is a packet-switched network.

11. The device of claim 9, wherein said data network is an Ethernet passive optical network (EPON).

12. The device of claim 9, the device further comprising:
(d) a configuration register operative to disable said detection.

13. The device of claim 9, wherein said at least one discard functionality includes at least one functionality selected from the group consisting of: a flag counter, a logical link identifier, a tag offset, a discard decision, and a configuration-dependent indication.

14. The device of claim 9, wherein said at least one discard functionality is configured to be attached to said discard-designated frame.

15. The device of claim 9, wherein said discard-designated frame is configured to be routed to at least one alternate destination based on said at least one discard functionality.

16. The device of claim 15, wherein said at least one alternate destination includes a network management system.
